(19) United States
(12) Patent Application Publication
(10) Pub. No.: US 2004/0088349 A1
(43) Pub. Date: May 6, 2004

(54) Method and apparatus for providing anonymity to end-users in web transactions

(76) Inventors: Andre Beck, Woodbridge, NJ (US); Markus Hofmann, Fair Haven, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/284,220

(22) Filed: Oct. 30, 2002

(51) Int. Cl. G06F 15/16

(52) U.S. Cl. 709/203

(57) ABSTRACT

An Internet Service Provider (ISP) intercepts HTTP requests from an end-user's browser, which are addressed to a Web server with which the ISP has an arrangement. If the request does not already include one, the request is modified to include a temporary user ID token that is identifiable with the end-user only by the ISP and not by the Web server. In response to receiving a request from the end-user that includes a token, the Web server generates a responsive message to the ISP that includes that same temporary user ID token, and which requests the ISP to perform a user-specific action. In response to that message, the ISP identifies the user from the token, performs the requested user-specific action and provides the Web server with information relating to the result of the requested action. The Web server then generates a response to the end-user's original request utilizing the provided information.

### TECHNICAL FIELD

This invention relates providing anonymity to an end-user who is engaged in a transaction with a Web server.

### BACKGROUND OF THE INVENTION

An end-user while interacting over the Internet with a third-party application running on a Web server that provides certain services may not be desirous of providing his identity or other personal information to the Web site that supports the application. For example, an end-user may wish to make a purchase from a Web site such as amazon.com or barnesandnoble.com, but doesn't want a profile of his purchases to be developed by the Web site and thus wants to remain anonymous to the Web site with respect to his purchasing activities. Further, the end-user may wish to engage in a transaction but doesn't want to disclose his credit card number over the Internet to the Web site. Rather than disclosing end-user specific information directly to a third-party Web service, it would be preferable from the end-user's standpoint to provide such personal information to a trustworthy third party who would then conduct the transaction with the third-party Web service on behalf of the end-user, while maintaining the end-user's anonymity to that service. For example, the trustworthy third party could conduct a transaction involving the exchange of money with a third-party Web service running at a Web site with which it has made a payment collection arrangement. The trustworthy third party would then debit an end-user's account for the transaction and then credit the account of the proprietor of the Web site. The trustworthy third party would then collect the funds from the end-users either by conventional means and transfer those funds to the Web site proprietor. Accordingly, an arrangement that permits an end-user to interact anonymously with third-party applications running on Web servers is desirable.

### SUMMARY OF THE INVENTION

In accordance with the present invention, an end-user's Internet Service Provider (ISP) acts as an intermediary and trustworthy third party in transactions between the end-user and a third-party application running on a Web server at a Web site, which has an established arrangement with the ISP. The ISP intercepts an HTTP request from an end-user's browser running on a client terminal that is addressed to that Web server and modifies that request to include a temporary user ID token, if the request does not already include one. That temporary user ID token, generated by the ISP and stored by the ISP in association with the end-user's identity, can only be associated with the end-user by the ISP and cannot be associated with the end-user by Web server. The end-user's HTTP request, which includes this temporary user ID token, and which also has an associated expiration date, is then forwarded to the Web server, which, upon receiving the request and detecting the temporary user ID token within the request, generates a responsive message to the ISP that includes that same temporary user ID token, and which requests the ISP to perform a user-specific action. The ISP, upon receiving the Web server's message and parsing the temporary user ID token from that message, identifies from the token the end-user for whom the user-specific action is to be performed, determines whether the token is still valid, and ascertains whether the identified end-user has granted explicit or implicit permission for the requested action to be performed. If permission has been granted and the token is still valid, the ISP performs the user-specific action and responds to the Web server by providing the result of the requested action. The Web server then utilizes the ISP-provided information to generate a response to the end-user's original request.

Various mechanisms can be employed by the ISP for inserting a temporary user ID token into an HTTP request generated by an end-user's browser. In a first embodiment, the ISP intercepts or redirects an end-user's request to an application-level intermediary device in the transit path between the end-user and the third-party application running on a Web server. The intermediary device then generates the temporary user ID token and inserts that token into the end-user's request (together with possibly other information such as an address at the ISP to which the Web server is to respond) as value. The ISP then stores the relationship between the assigned temporary user ID token and the end-user's identity in a database. The modified HTTP request is then forwarded to the Web server to which it is addressed and the third-party application running on that server parses the request to retrieve the token. Depending upon the request, the Web server responds to the ISP with a message that includes the token and which requests the ISP to perform a user-specific action.

In a second embodiment, the HTTP cookie mechanism is used to transport the temporary user ID token (and possibly other information such as the ISP address to which the Web server is to send its message requesting a user-specific action) to the Web server. In this embodiment, the end-user's browser is requested to include a cookie containing the token and the other information in each request directed to the Web server. In order to instruct the browser to include the cookie, the ISP first passes an unmodified request from the end-user to the Web server. The first response from the third-party application running on the Web server is intercepted by an application-level intermediary at the ISP and a Set-Cookie header containing the temporary user ID token generated by the ISP and the other information to be included in the cookie as noted above is inserted into the response. That modified response from Web server is then passed to the end-user's browser, which thereafter automatically includes that token (and the other information in the Set-Cookie header) as a cookie in all subsequent requests to that Web server throughout the length of the session as determined by the cookie's expiration date. These subsequent requests, which thus already contain the token and other information in the cookie, are passed unmodified by the ISP to the third-party application running on the Web server. The Web server, upon detecting the cookie in the request, sends a message to the ISP at the specified address requesting that a user-specific action be performed. This embodiment advantageously does not require the ISP to insert information into each request that is made by the end-user's browser and is directed to the same third-party application running on a particular Web server.

### BRIEF DESCRIPTION OF THE DRAWING

FIG. 1 is a block diagram of a network showing a client, a Web server running a third-party application within a Web site that is connected to the Internet, and an ISP network that utilizes an intermediary device to intercept and modify requests passing through it from the client to the Web server so as to include in the request, if not already present, a temporary user ID token, and which ISP network, in response to a message containing the token from the Web site, performs a user-specific action and reports the results of that action to the Web server;

FIG. 2 is a block diagram of the service platform architecture of an embodiment of the intermediary device in FIG. 1;

FIG. 3 is flowchart showing the steps according to a first embodiment of the invention in which each end-user's request to the Web site is modified by inserting an HTTP header that includes the temporary user ID token; and

FIG. 4 is a flowchart showing the steps according to a second embodiment of the invention in which the end-user's browser is instructed to include an HTTP cookie that contains the temporary user ID token into requests to the Web server.

### DETAILED DESCRIPTION

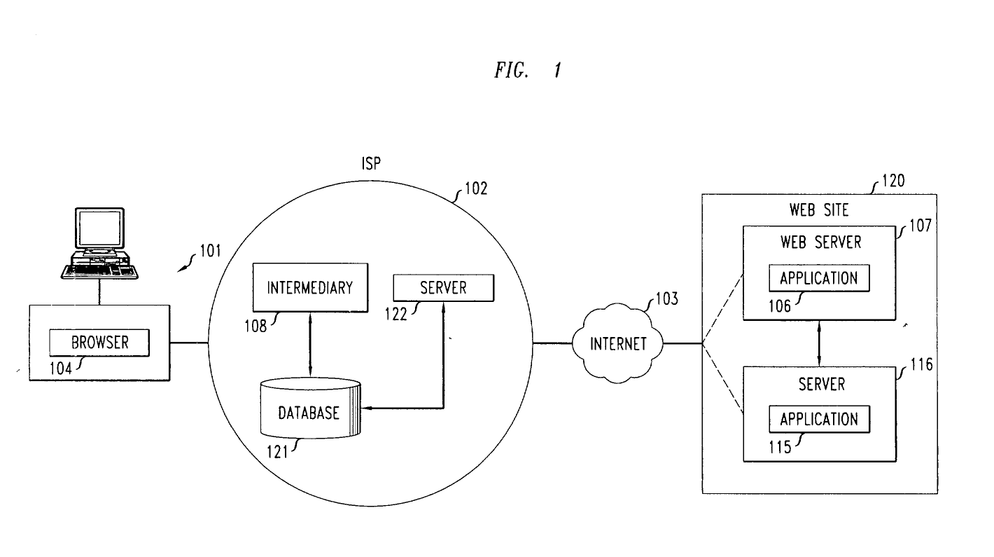

With reference to FIG. 1, a client 101 is shown connected to an Internet Service Provider (ISP) network 102, which provides access to the Internet 103. The client 101 can be connected to the ISP 102 through the POTS (Plain Old Telephone Service) network (not shown) using a standard voice-band modem, over a DSL connection through the local telephone company, over a cable-TV connection using a cable modem, over a wireless connection, or any other wired or wireless arrangement. The client 101 can be any type of client including, for example, a standard computer terminal, a PDA, an Internet-enabled cellular telephone, or any other type of client device. The client 101, which is running a conventional browser program 104 appropriate for its client type, is desirous of engaging in a transaction with third-party application 106 running on a Web server 107 at a Web site 120. The end-user, however, wishes to maintain anonymity with respect to that application 106, not revealing his identity or other user-specific information that the application 106 may find useful or necessary in formulating a response or concluding a transaction in response to a request. In order to maintain end-user anonymity, an intermediary 108, at the edge of the network within the ISP network 102, modifies the HTTP requests issued by either the browser 104 or the responses to a token-less request from the application 106, as will be described, to insert into the request or response an ISP-generated temporary user ID token that is associated only with the specific end-user generating the request and is identifiable with that end-user only by the ISP. As such, the Web server 107 receiving the request cannot determine the end-user's identity from the temporary user ID token.

Intermediary 108 is a device described by the present inventors in an article entitled “Enabling the Internet to Deliver Content-Oriented Services,” Proceedings of Sixth International Workshop on Web Caching and Content Distribution (WCW), Boston, Mass., Jun. 20-22, 2001, which is incorporated by reference herein. That article describes in detail a service platform architecture that extends the existing network edge infrastructure towards a flexible and open platform for a variety of new content services. This platform makes use of and extends existing intermediary devices, such as caching proxies and content-aware switches, enabling them to perform specific tasks on the application-layer content that is routed through them. That intermediary device is also described by the current inventors in a co-pending patent application Ser. No. 10/135,920 filed on Apr. 30, 2002, also incorporated by reference herein. In that co-pending application, the intermediary is used for providing additional intelligent value-added services by operating on a request and its response message stream passing through it going to and coming from a content provider's server so as to determine from the content of a response to a request whether additional context-specific information should be made available to the user when the requested response is delivered to the user's client.

As used in herein, the intermediary 108 within ISP 102 is used to intercept requests addressed to a specified URL and/or responses from that URL addressed to the end-users IP address, depending on the embodiment described below, to determine whether a temporary user ID token is needed and if so, whether the token is already present. Thus, intermediary 108 operates to incorporate a temporary user ID token within requests made to third-party applications running on Web servers at Web sites that have a pre-established relationship with ISP 102. Assuming that Web server 107 at Web site 120 has such a relationship, a separate application 115 running on Web server 107, or on an associated server 116 within the environment of Web site 120, performs these Web site-based functionalities. As will be described, these functionalities include: 1) recognizing a request containing a temporary user ID token; 2) in response to receiving such a request containing a temporary user ID token, generating a response that contains that token and which includes in the response a request that the ISP perform a specific user-specific action; and 3) in response to receiving from the ISP the results of that user-specific action, acting upon those results in formulating a response to the request.

In a first embodiment of the invention, an ISP-generated temporary user-ID token is inserted by intermediary 108 into an HTTP header in each request from the end-user's browser 104 that is addressed to a Web site with which the end-user's ISP 102 has established a relationship such as, for example Web site 120. Accordingly, ISP 102 intercepts each request and diverts each such request to intermediary 108. Intermediary 108, using the URL to which the request is addressed, then determines whether the request needs to be modified by the inclusion of a temporary user ID token in an HTTP header before it is forwarded to its destination address. If the URL to which it is addressed is not that of a Web site with which the ISP and the Web site have an established arrangement, then the unmodified request is forwarded directly to the Web site to which it is addressed. If, on the other hand, the URL is that of a Web site which has established a relationship with the ISP, then intermediary 108 modifies the request by inserting into the request an HTTP header containing a temporary user ID token, as well as other information.

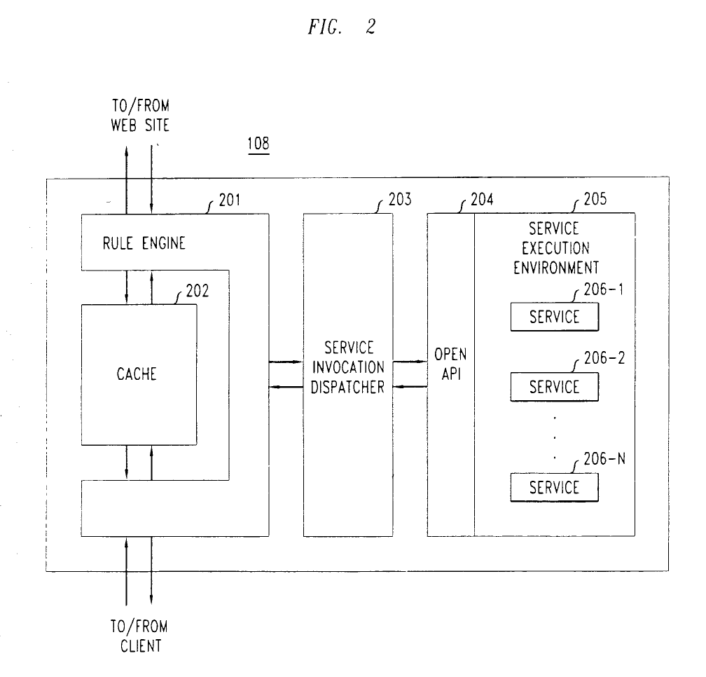

FIG. 2 shows a block diagram of an embodiment of the intermediary 108 that intercepts end-user-initiated requests and responses to such requests. Intermediary 108 includes a rule engine 201, a cache 202, a service invocation dispatcher 203, an open API 204, and a service execution environment 205 containing a plurality of service modules 206-1-206-N. Rule engine 201 examines each request to determine, based on the destination URL, whether it needs to be modified by the inclusion of an HTTP header containing a temporary user ID token. If a determination is made that the request should be modified, a request-modifying service module 206 is invoked to perform the modification. Various mechanisms can be employed to determine whether the destination URL in the request is one for which the request should be modified. For example, a table of URLs can be used to specify those URLs for which a request or a response requires inclusion of a token. Alternatively, a URL classification scheme can be used to match the request's destination URL against a large database of rules that are expressed as real expressions. Such a URL classification scheme is described in co-pending application Ser. No. 10/230,444, filed Aug. 29, 2002, which is incorporated herein by reference. Further, a proposed standardized Intermediary Rule Markup Language (IRML) can be used to specify rule conditions that would invoke the request-modifying service module 206 in the intermediary 108. This standardized rule specification language has been proposed and submitted to the IETF standards body for the exchange of rules between rule authors and service platforms (see, e.g., A. Beck, M. Hofmann: “IRML—A Rule Specification Language for Intermediary Services”, Internet Draft, IETF, November 2001, available at http://search.ietf.org/internet-drafts/draft-beck-opes-irml-02.txt), also incorporated herein by reference The proposed standardized Intermediary Rule Markup Language is an example of a rule language that can be used and other rule languages could be devised by those skilled in the art. A standardized rule language advantageously allows rule authors to specify rules for network edge services in a standard format. Thus, if a standardized language is used, rules can be distributed to different service platforms owned by different access providers in the same standard format. IRML is an application of the Extensible Markup Language (XML). Thus, the IRML syntax is governed by the rules of the XML syntax (see, e.g., T. Bray, J, Paoli, C. M. Sperberg-McQueen, and E. Maler, “Extensible Markup Language (XML) 1.0” (Second Edition), W3C Recommendation, W3C, October 2000), which is well known to those skilled in the art, and the IRML grammar is specified by a DTD, a Document Type Definition.

If rule engine 201 determines from its destination URL that the end-user-originated request requires the inclusion of an HTTP header containing a temporary user ID token before being forwarded to its destination, then a specific service module 206 is invoked that can generate that token and insert an HTTP header containing that token and other information into the request. That service module 206 thus generates a random or pseudo-random token that is meaningless on its own, but indicates to the ISP the identity of the particular end-user who originated the request. The relationship between the end-user's identity and the assigned token is stored in an associated database 121 in the domain of ISP 102 (in FIG. 1) and thus only the ISP can determine the end-user's identity from the temporary user ID token assigned to him. The end-user's identity can be determined using one of various techniques that are known for associating network usage with particular users. One such technique is described in co-pending patent application Ser. No. 09/315,636 filed May 20, 1999.

When the rule engine 201 determines that the specific service module 206 that performs the token generation and header insertion tasks is to be invoked, the invoked service module 206 is then provided with the corresponding request messages. The service invocation dispatcher 203 performs these tasks. Specifically, the rule engine 201 notifies the service invocation dispatcher 203 that a particular service module 206 within the service execution environment 205 is to be invoked. Although all service modules 206 are shown to be local to the intermediary 108 in FIG. 2, it is possible that some service modules may be resident upon a dedicated service execution server, where the particular service is invoked. For this latter case, not shown in FIG. 2 but shown in the referred to and incorporated article, the service execution dispatcher 203 differentiates between local service modules and service modules on a remote server and directs the request to the remote service execution server for processing if the invoked service module is not a local service module but is resident on the remote server

The open API (Application Program Interface) 204 provides the interface from the service invocation dispatcher 203 to the service execution environment 205 containing the plural service modules 206. After the particular service module 206 inserts the HTTP header containing the temporary user ID token and other information into the request, the modified request is returned through the open API 204, the service invocation dispatcher 203, and the rule engine 201, and onto the Internet to the Web server to which it is addressed. The other information included in the HTTP header in the modified request comprises information such as an expiration date of the token and an address through which the destination Web site 120 can directly communicate with ISP 102, as well as the protocol to be used for that direct communication between ISP 102 and Web site 120. The format of that HTTP header need be agreed upon in advance with the Web site 120 so that the message components of the header can be properly recognized when received by the Web site.

As noted above, an application 115 running on a separate server 116 within the Web site environment 120 or running on Web server 107 as a separate application (not shown) from the third-party application 106 to which the request is directed, extracts the inserted HTTP header from the received request and parses the temporary user ID token, and the information transmitted within that header. Application 115, upon detecting the presence of a temporary user ID token, and using the address indicated in the HTTP header, opens a communication channel with the ISP and engages in a direct communication with an application running on a server 122 within the domain of ISP 102. Specifically, the application 115 generates and sends a message that includes: credentials for authenticating its origin Web site 120 with ISP 102, the received temporary user ID token that was included in the HTTP header in the received request; and a user-specific action that the ISP is being requested to perform and which relates to the end-user-originated request received by the third-party application 106 running on Web server 107.

After the application running on server 122 authenticates the origin of the message as being properly that of Web site 120, it then, using the temporary user ID token in the message, determines the identity of the end-user from database 121. Having determined the identity of the end-user, the application determines whether the requested user-specific action is an action that is explicitly or implicitly authorized by that end-user and whether the token is still valid. If the token is still valid and the user-specific action is authorized, the user-specific action is then either performed by an application running on server 122 or is delegated to be performed by another application running on another server within the ISP's domain 102. After the user-specific action has been performed, the result of that action, such as an indication that the action has been performed or other information, is reported back to the third-party application 106 running on Web server 107 within the Web site domain 120. Web server 107 then generates a response to the modified request sent to it that is addressed to the origin address in that request, using the ISP-provided information, as it is needed, to formulate that response.

As described above, each time the end-user's browser 104 makes a request to any Web site with which ISP 102 has an established relationship, that request is modified by the inclusion of an HTTP header containing a temporary user ID token. That token enables the end-user to maintain his anonymity to such Web site by using the trustworthy ISP as his agent in the transaction. That same temporary user ID token can be used by the same end-user throughout a session, or the intermediary can periodically change it. By increasing the frequency at which the token is changed, the privacy protection afforded the end-user is improved. At its maximum limit, intermediary 108 can assign a different temporary user ID token for each new request.

In a second embodiment of the invention, HTTP cookies rather than HTTP headers are used as the mechanism to transport a temporary user ID token (and possibly other information) to third-party applications running on a Web server. As is well known, cookies are a general mechanism that allow a server side application to both store and retrieve information on the client side of the connection. A cookie is introduced to the client by including a Set-Cookie header as part of an HTTP response. Any future HTTP requests made by the client to the same server-side application will include an HTTP header containing the value of the previously Set-Cookie.

In this embodiment, intermediary 108 needs to intercept both end-user browser-originated requests to a third-party application 106 running on a Web server 107 and the responses to those requests from that Web server that are destined to the end-user's browser. When the end-user makes a request through his browser 104, intermediary 108 intercepts that request so that rule engine 201 can determine whether the Web site to which the request is directed is a Web site with which ISP 102 has made an arrangement requiring the inclusion within the request of a temporary user ID token. If, based on the destination URL of the request, rule engine 201 determines that such a token is needed, then a determination is made whether a token is already included in the request. If the request doesn't already include that token, intermediary 108 passes the unmodified request onto the Internet to the destination Web server 107 and then intercepts the response from Web server 107 to that token-less request. A service module 206 within intermediary 108 then modifies the response to include a Set-Cookie header. That header includes a temporary random or pseudo-random user ID token that is generated by the service module 206 and is assigned to the end-user until the cookie's expiration date. Typically, the cookie will remain valid until the end of the user's browsing session, at which time the stored cookie is discarded. As in the previously discussed embodiment, the cookie also includes additional information such as an ISP address to which the Web server 107 should communicate to request a user-specific action and a protocol for such communication. Intermediary 108 then forwards the modified response containing the Set-Cookie header with its associated temporary user ID token and additional information to the end-user's Web browser 104.

All subsequent requests issued by Web browser 104 and addressed to Web server 107 will thereafter include a cookie that comprises the temporary user ID token and the additional information specified in the Set-Cookie header. The next request, issued either automatically by browser 104 or through an end-user action is then intercepted by intermediary 108 and forwarded directly to Web server 107 since it already contains the temporary user ID token. As in the previously described embodiment, application 115 running on Web server 107 or on server 116 within Web site 120 extracts the token from the cookie and opens a communication channel to the ISP at the address specified in the cookie and using the protocol specified in the cookie. As in the HTTP header embodiment previously described, a message is sent to the ISP that includes this same temporary user ID token and which requests the ISP to perform a user-specific action. If the end-user has given permission for that requested action to be performed and if the token is still valid, the ISP performs the requested user-specific action and responds to Web site 120 with the results of the requested action. Web server 107 then generates its response to the end-user utilizing the ISP-provided information.

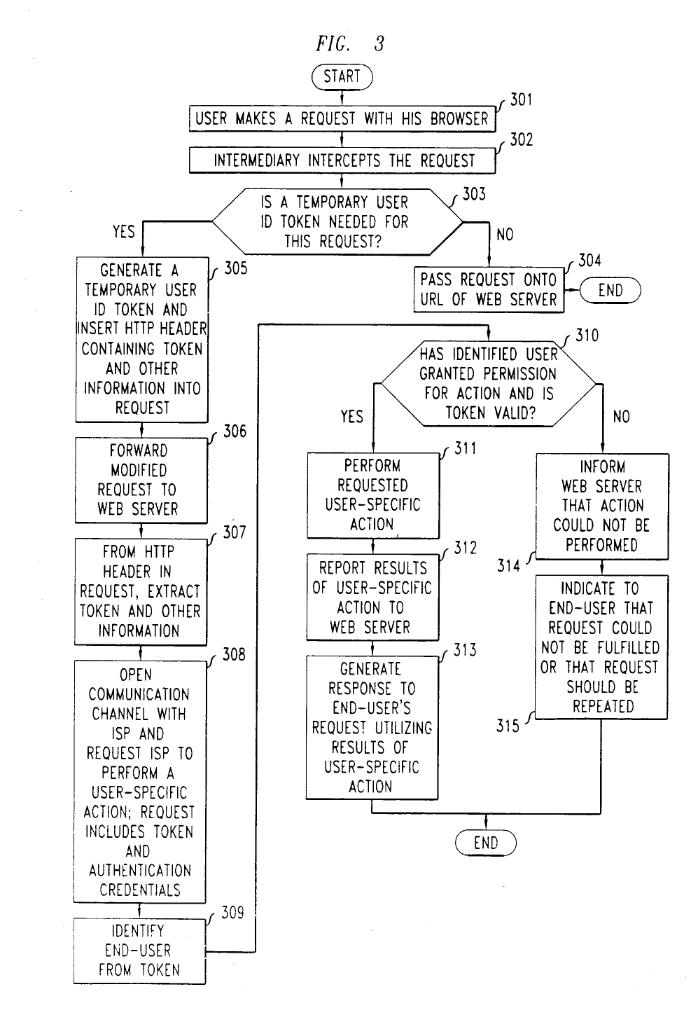

With reference to FIG. 3, which shows a flowchart that summarizes the steps associated with the HTTP header mechanism described above, at step 301, the end-user makes a request with his browser to a specified URL. At step 302, the intermediary intercepts the request, and at step 303, a determination is made whether a temporary user ID token is needed for this request to the specified URL. If the request is to a URL for which no arrangement between the ISP and the Web server is in place, then a token is not needed and, at step 304, the request is passed directly to the URL of that Web server. If a determination is made at step 303 is that a token is needed, then, at step 305, a temporary user ID token is generated by the intermediary and the request is modified by the inclusion of an HTTP header that comprises that token and the above-described other information. At step 306, the modified request is forwarded to the Web server. At step 307, the Web server extracts the token from the request and, at step 308, the Web server opens a communication channel with the ISP and sends a message to the ISP requesting that a user-specific action be performed. This message includes the token and Web server authentication credentials. At step 309, the ISP identifies the end-user from the token in the message and, at step 310, using the end-user's identity, determines whether the end-user has granted permission for the requested action, and whether the token is still valid. If both are affirmative, then, at step 311, the ISP performs the requested user-specific action. At step 312, the ISP reports the results of the requested user-specific action to the Web server and, at step 313, the Web server generates a response to the end-user's request utilizing the ISP-provided information. If, at step 310, the determination is that the end-user has not granted permission for the Web-server-requested user-specific action or if the token is no longer valid, then, at step 314, the ISP responds to the Web server indicating to it that it could not perform the requested action. At step 315, the Web server can either ask the end-user to repeat the request, or indicate to the end-user that the request was unable to be fulfilled.

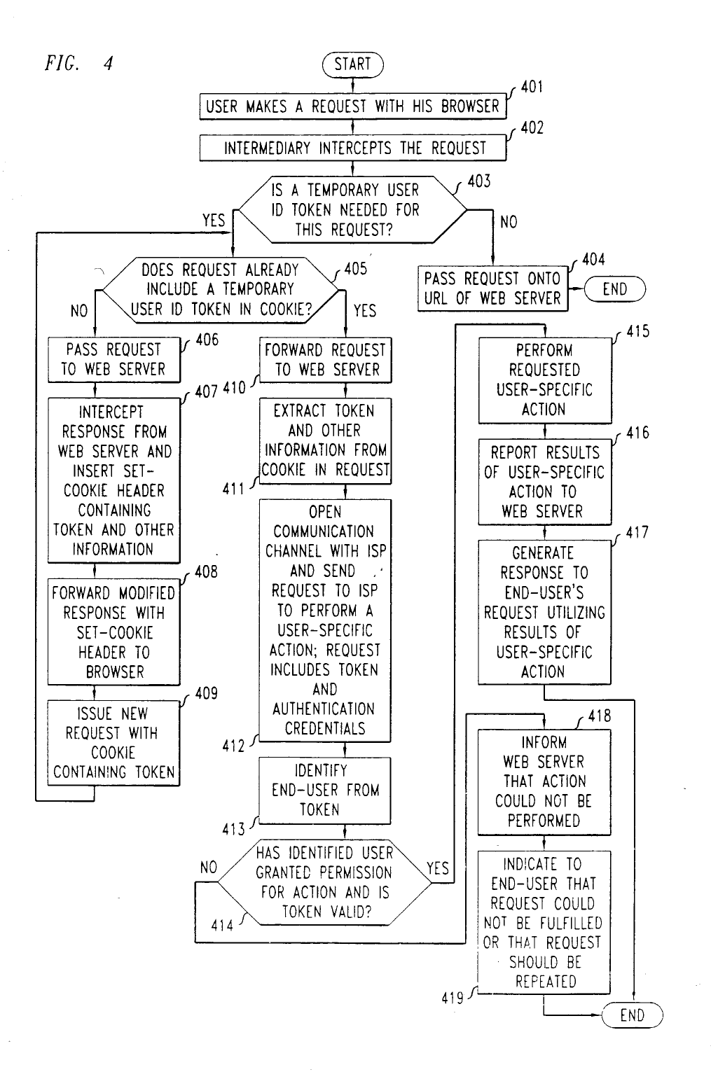

With reference to FIG. 4, which shows a flowchart that summarizes the steps associated with the HTTP cookie mechanism described above, at step 401, the end-user makes a request with his browser to a specified URL. At step 402, the intermediary intercepts the request, and at step 403, determines whether a temporary user ID token is needed for this request to the specified URL. If the request is to a URL for which no arrangement between the ISP and the Web server is in place, then a token is not needed and, at step 404, the request is passed directly to the URL of that Web server. If a token is determined to be needed at step 403, then, at step 405, a determination is made whether the request already includes a cookie that contains a temporary user ID token. If it doesn't contain a cookie, then, at step 406, the request is passed unmodified to the Web server. At step 407, the intermediary intercepts the Web server response to that request and inserts a Set-Cookie header containing the temporary user ID token and other information, as discussed above. At step 408, the intermediary forwards that modified response containing the Set-Cookie header to the end-user's browser. At step 409, the end-user's browser, automatically or under the control of the end-user, issues a new request that contains the cookie. When, at step 405, the intermediary intercepts this new request, it determines that it includes that a cookie containing this temporary user ID token. At step 410, therefore, the intermediary forwards the request containing the cookie to the Web server to which it is addressed. At step 411, the Web server extracts the token and the other information in the cookie and, at step 412, opens a communication channel between the Web server and the ISP. Using the communication channel, the Web server sends a message to the ISP containing the temporary user ID token and requesting the ISP to perform a user-specific action. At step 413, the ISP identifies the end-user from the token in the message and determines, at step 414, whether the identified user has granted permission for the requested action and whether the token is valid. If permission has been granted and the token is valid, then, at step 415, the ISP performs the requested user-specific action. At step 416, the ISP reports the results of that user-specific action to the Web server over the open communication channel. At step 417, the Web server then generates a response to the end-user's request utilizing the results of the user-specific action. If, at step 414, a determination is made that the end-user has not granted permission for the requested user-specific action, or that the token is no longer valid, then, at step 418, the ISP informs the Web server that the action could not be performed and, at step 419, an indication is given to the end-user that the request could not be fulfilled or that the request should be repeated.

Modifications of the HTTP cookie mechanism can be made that eliminate sending the initial end-user's browser request to the Web server without the inclusion of a temporary user ID token. In a first modification, the request generated by the end-user's browser 104 is intercepted by the intermediary 108, which inserts a cookie containing a temporary user ID token into that request in a manner that appears as if it were inserted by a browser. The Web server 107, upon receiving a request that includes the temporary user ID token within the cookie then generates a response to the end user's browser that includes a Set-Cookie header that comprises the temporary user ID token and a request that the browser include this cookie containing the temporary user ID in all subsequent requests to it during the current session. The intermediary will then forward, without modification, all such subsequent requests within the current session from browser 104 that are addressed to this same Web server 107 since they already include the temporary user ID token.

In a second modification of the HTTP cookie mechanism, when the intermediary 108 intercepts a request from browser 104 that doesn't include a temporary user ID token in a cookie, it responds to the request directly rather than forwarding the request to the Web server to which the request is addressed. The response to the end-user's browser 104 includes a Set-Cookie header that comprises the temporary user ID token generated by intermediary 108 and a request that the browser automatically repeat the request, which will now include the cookie. The browser 104 will include the cookie in this repeated request and in all subsequent requests to the same Web server, and the intermediary will forward each such request containing the cookie that is addressed to that same Web server without further modification.

Either the first or second modifications to the HTTP cookie mechanism described above will result in a change to the flowchart in FIG. 4. Other modifications to the HTTP cookie mechanism are also possible.

Advantageously, the HTTP cookie mechanism, as compared with the HTTP head mechanism, does not require information to be inserted into each HTTP transaction between end-users and third-party applications, thus improving the overall performance. The HTTP cookie mechanism does not, however, allow the end-user to disable support for cookies in his browser.

The above-described embodiments can be used for various applications in which Web applications require user-specific information that the end-user may not want to provide directly. As a first example, a wireless operator may utilize the described invention to provide a third-party Web application with real-time information on the location of mobile Internet users. In this scenario, a Web application could use this information to localize their content, for example by displaying a directory of nearby restaurants or by providing mobile users with local weather forecasts. The exchange of location information between the service provider and the third-party application would include the temporary user ID token so that the service provider (but not the third-party application) can identify the mobile user. The information exchange could be performed transparently to the mobile user and could also be user-permission-based by allowing the end-user to grant and revoke permissions for the exchange of user-specific information between his service provider and a third-party application. Specifically, as applied to the description of the invention above, in the communication between the third-party application (or the separate application running along side of it or on top of it) and the service provider, the third-party application requests the ISP to perform an action, which consists of determining the location of the end-user, which the service provider is capable of determining. The service provider, after determining the identity of the mobile end-user from the token within the communication, and determining that the end-user has authorized that such information be provided, performs that action and provides the requested location information to the third-party application. The third-party application then uses that location information to formulate a customized response to the third party's original request.

As a second example, a Web application that charges end-users for an online service may utilize the above-described invention to transparently bill users. For example, an online music store may want to charge end-users a small amount for every download of a music track. While traditionally, these micro-payments involve a direct billing relationship between the end-user and online store, this would not be necessary if the online store used the billing capability of the user's ISP. In this scenario, the ISP would act as an intermediary between the end-user and the online store and handle the billing transaction with the end-user on behalf of the online store. Additionally, the end-user would not have to disclose his identity to the online store because the online store would only need the temporary user ID token to initiate the billing transaction with the ISP. Specifically, in the communication between the online store and the ISP, the online store requests the ISP to perform an action, which consists of charging an account associated with the end-user for the cost of the requested download. The ISP, upon receiving that request, determines the actual identity of the end-user from the token included in the communication from the online store, and then determines whether such transactions with the identified online store have been authorized by the end-user. If such a purchase is authorized by the end-user, then the ISP debits the end-user's account for the cost of the download of the music track and credits the online store's account for the transaction. If that transaction is successful (i.e., the charge is accepted by end-user's account), the ISP informs the online store of the success of the action and the online store then proceeds to download the requested music track to the end-user.

In a third example, temporary user ID tokens could be used to enable an ISP to share with a Web server information about the end-user's Internet access device as well as information about the bandwidth of the end-user's access link to the Internet. For example, if a user is connected to the Internet through a high-speed Internet connection such as DSL or cable, then the Web server can respond to a user request with multimedia-enriched content. On the other hand if the Web server determines that the end-user is connected to the Internet through an analog modem or a mobile access device with a slow Internet connection, then the Web server could respond with a scaled-down version of its content. As in the examples above, the Web server requests the ISP to perform an action, which consists of providing information about the end-user's Internet access device and access link bandwidth. After the ISP responds to the Web server with that information, it uses that information to formulate its response to the end-user's original request in a format appropriate for that end-user's client type.

In a fourth example, temporary user ID tokens could enable an ISP to share information with a Web server about an end-user's shopping preferences without revealing the end-user's identity. For example, an end-user could specify his shopping preferences to his ISP and also authorize his ISP to release this information to certain Web servers (without revealing the end-user's identity). A Web server could use this information to automatically create a personalized shopping experience that is customized to the end-user's shopping preferences. The privacy of the end-user will remain protected since the temporary user ID token ensures his anonymity towards the Web server.

The foregoing merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be further appreciated by those skilled in the art that the block diagrams herein represent conceptual views embodying the principles of the invention. Similarly, it will be appreciated that the flowchart represents various processes that may be substantially represented in computer readable medium and so executed by a computer or processor, whether or not such computer or processor is explicitly shown.

The invention claimed is:

1. A method comprising:
at an Internet Service Provider (ISP):
receiving an end-user's request addressed to a Web server;
inserting a temporary token into the received request if the request does not already contain a temporary token, the temporary token being generated by the ISP and stored in association with the end-user's identity, the end-user's identity not being determinable by the Web server from the temporary token;
forwarding the request containing the temporary token to the Web server;
performing, using the stored association of the temporary token and the user's identity, a requested user-specific action specified in a message containing the temporary token that is received from the Web server in response to the request; and
providing information to the Web server relating to the result of the user-specific action that is used by the Web server to formulate a response to the end-user's request.

2. The method of claim 1 wherein the temporary token is inserted into an HTTP header in the end-user's request.

3. The method of claim 2 wherein a new temporary token is generated for each new request from the end-user that is addressed to the Web server.

4. The method of claim 2 wherein the HTTP header also includes an address at the ISP for the Web server to send the message requesting the user-specific action.

5. The method of claim 4 wherein the HTTP header also includes a protocol to be used by the Web server for sending the message requesting the user-specific action.

6. The method of claim 1 wherein the user-specific action is performed only if a determination is made that the end-user granted permission for it to be performed.

7. The method of claim 1 wherein the temporary token has an expiration date and the user-specific action is performed only if the temporary token in the message requesting the user-specific action has not expired.

8. The method of claim 1 wherein the message requesting the user-specific action also contains credentials for authenticating the Web server as the source of the message.

9. The method of claim 1 wherein the token is a random or a pseudo-random number.

10. The method of claim 1 wherein if the request already contains a temporary token, it is within an HTTP cookie.

11. The method of claim 10 wherein the cookie has an expiration data and the user-specific action is performed only if the cookie has not expired.

12. The method of claim 11 wherein the cookie remains valid until a current browsing session of the end-user has ended.

13. The method of claim 10 wherein the HTTP cookie includes an address at the ISP for the Web server to send the message requesting the user-specific action.

14. The method of claim 13 wherein the HTTP cookie includes a protocol to be used by the Web server for sending the message requesting the user-specific action.

15. A method comprising:
at an Internet Service Provider (ISP):
receiving an end-user's request addressed to a Web server,
sending an instruction to a browser of the end-user to include a temporary token in all subsequent requests addressed to the Web server, the temporary token being generated by the ISP and stored in association with the end-user's identity, the end-user's identity not being determinable from the temporary token;
forwarding a subsequent request containing the temporary token received from the end-user and addressed to the Web server;
performing a user-specific action specified in a message containing the temporary token that is received from the Web server in response to the subsequent request;
performing, using the stored association of the temporary token and the user's identity, a requested user-specific action specified in a message containing the temporary token that is received from the Web server in response to the subsequent request; and
providing information to the Web server relating to the result of the user-specific action that is used by the Web server to formulate a response to the subsequent request.

16. The method of claim 15 wherein the instruction to the browser to insert the temporary token into subsequent requests is a Set-Cookie header containing the temporary token and the subsequent request includes the temporary token in an HTTP cookie.

17. The method of claim 16 wherein the Set-Cookie header further contains an address at the ISP for the Web server to send the message requesting the user-specific action, and the HTTP cookie includes that address.

18. The method of claim 17 wherein the Set-Cookie header further contains a protocol to be used by the Web server for sending the message requesting the user-specific action, and the HTTP cookie includes that protocol.

19. The method of claim 15 wherein the user-specific action is performed only if a determination is made that the end-user granted permission for it to be performed.

20. The method of claim 16 wherein cookie has an expiration date and the user-specific action is performed only if the has not expired.

21. The method of claim 20 wherein the cookie remains valid until a current browsing session of the end-user has ended.

22. The method of claim 15 wherein the message requesting the user-specific action also contains credentials for authenticating the Web server as the source of the message.

23. The method of claim 15 wherein the token is a random or a pseudo-random number.

24. A computer readable media tangibly embodying a program of instructions executable by a computer to perform a method, the method comprising:
receiving an end-user's request addressed to a Web server;
inserting a temporary token into the received request if the request does not already contain a temporary token, the temporary token being generated by an ISP and stored in association with the end-user's identity, the end-user's identity not being determinable from the temporary token;
forwarding the request containing the temporary token to the Web server;
performing, using the stored association of the temporary token and the user's identity, a requested user-specific action specified in a message containing the temporary token that is received from the Web server in response to the request; and
providing information to the Web server relating to the result of the user-specific action that is used by the Web server to formulate a response to the end-user's request.

25. Apparatus at an Internet Service Provider (ISP) comprising:
means for receiving an end-user's request addressed to a Web server;
means for inserting a temporary token into the received request if the request does not already contain a temporary token, the temporary token being generated by the ISP and stored in association with the end-user's identity, the end-user's identity not being determinable by the Web server from the temporary token;
means for forwarding the request containing the temporary token to the Web server;
means for performing, using the stored association of the temporary token and the user's identity, a requested user-specific action specified in a message containing the temporary token that is received from the Web server in response to the request; and
means for providing information to the Web server relating to the result of the user-specific action that is used by the Web server to formulate a response to the end-user's request.
